(19) United States
(12) Patent Application Publication
(10) Pub. No.: US 2005/0079831 A1
(43) Pub. Date: Apr. 14, 2005

(54) Signal strength indicator for a wireless card

(75) Inventor: Puthukode G. Ramachandran, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/682,392

(22) Filed: Oct. 9, 2003

(51) Int. Cl. H04Q 7/20

(52) U.S. Cl. 455/90.3

(57) ABSTRACT

A method, apparatus, and computer instructions for identifying signal strength in a wireless network card. The wireless network card includes a housing, a bus interface, a transceiver, a data buffer, a display device, and a control unit. The bus interface is located inside the housing, wherein the bus interface provides a connection to a data processing system. The transceiver is located inside the housing. The transceiver sends and receives data from a wireless connection. The data buffer is connected to the bus interface and the transceiver, wherein the data buffer holds data for transfer between the bus interface and the transceiver. The display device is located on the exterior housing of the wireless network apparatus in a location for viewing by a human user. A control unit, located within the housing, controls the transfer of data through the data buffer, identifies the signal strength for the wireless connection, and displays the signal strength on the display device.

### BACKGROUND OF THE INVENTION

1. Technical Field

The present invention relates generally to an improved data processing system and in particular to a method and apparatus for indicating signal strength for a communications length. Still more particularly, the present invention relates to a method and apparatus for indicating signal strength for a wireless communication adapter.

2. Description of Related Art

Distributed network data processing systems are becoming more and more prevalent in businesses and in homes. Typically, a network data processing system contains a network with a medium used to provide communications links between various devices and computers connected within that network. Typically, this medium includes wires providing communications links with other devices, such as a router or a switch providing routing of data between the different devices on the network. One protocol used to transmit data within a network is the transmission control protocol/internet protocol (TCP/IP). This protocol is used on the Internet and also may be implemented in other networks, such as an intranet, a local area network (LAN), or a wide area network (WAN).

Wireless network connections are becoming more and more common, allowing for the introduction of networks in many locations in which running wires were previously inconvenient or prohibitively expensive. For example, many homes and small businesses as well as large corporations now use wireless communications links as a primary medium or an additional medium for providing access to a network. With a wireless network communications link, radio signals are used to broadcast information across this type of connection. Without requiring wires, networking is made extremely easy. For example, a laptop with a wireless network card is completely portable within the range of a hub or access point. An access point is a wire controller that receives and transmits data to wireless adapters installed in different data processing systems. Different types of wireless networks include, for example, Bluetooth, infrared data association (IrDA), and Wi-Fi, which uses IEE 802.11, which is a wireless Ethernet specification.

With a wireless network, the different data processing systems, such as workstations or laptop computers, use a wireless card or adapter to establish a connection with the access point. With respect to portable devices, such as laptop computers, a user may move the laptop to various locations. In some locations, the user may be unable to connect to the network because the strength of the wireless signal does not allow for a connection. Depending on the strength of the signal, the rate of data exchange may be less than desired by a user. Currently, no method or apparatus is present for determining the strength of a signal other than having the laptop connect to the network and using the software in the laptop to determine the strength of the signal. Having to start the laptop to determine the strength of the signal and then potentially having to move to another location can be time consuming and frustrating for a user to have to go through the different steps needed to determine the signal strength in the connection with a particular access point.

In other words, the user is required to open the laptop computer, start the laptop computer, and currently look at the software provided with the wireless card to identify the signal strength for a particular location. If the signal strength is insufficient or does not provide the appropriate rate of data transfer, the user then has to move the laptop computer to another location. This involves closing the laptop, moving to the next location, opening the laptop again, and checking the signal strength. Therefore, it would be advantageous to have an improved method and apparatus for identifying signal strength for a wireless adapter with respect to an access point.

### SUMMARY OF THE INVENTION

The present invention provides a method, apparatus, and computer instructions for identifying signal strength in a wireless network card. The wireless network card includes a housing, a bus interface, a transceiver, a data buffer, a display device, and a control unit. The bus interface is located inside the housing, wherein the bus interface provides a connection to a data processing system. The transceiver is located inside the housing. The transceiver sends and receives data from a wireless connection. The data buffer is connected to the bus interface and the transceiver, wherein the data buffer holds data for transfer between the bus interface and the transceiver. The display device is located on the exterior housing of the wireless network apparatus in a location for viewing by a human user. A control unit, located within the housing, controls the transfer of data through the data buffer, identifies the signal strength for the wireless connection, and displays the signal strength on the display device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a pictorial diagram of a wireless adapter card in accordance with a preferred embodiment of the present invention;

FIG. 3 is a diagram of a network adapter in accordance with the preferred embodiment of the present invention; and

FIG. 4 is a flowchart of a process for providing a signal strength indication in accordance with the preferred embodiment to the present invention.

### DETAILED DESCRIPTION OF THE PREFERRED EMBODIMENT

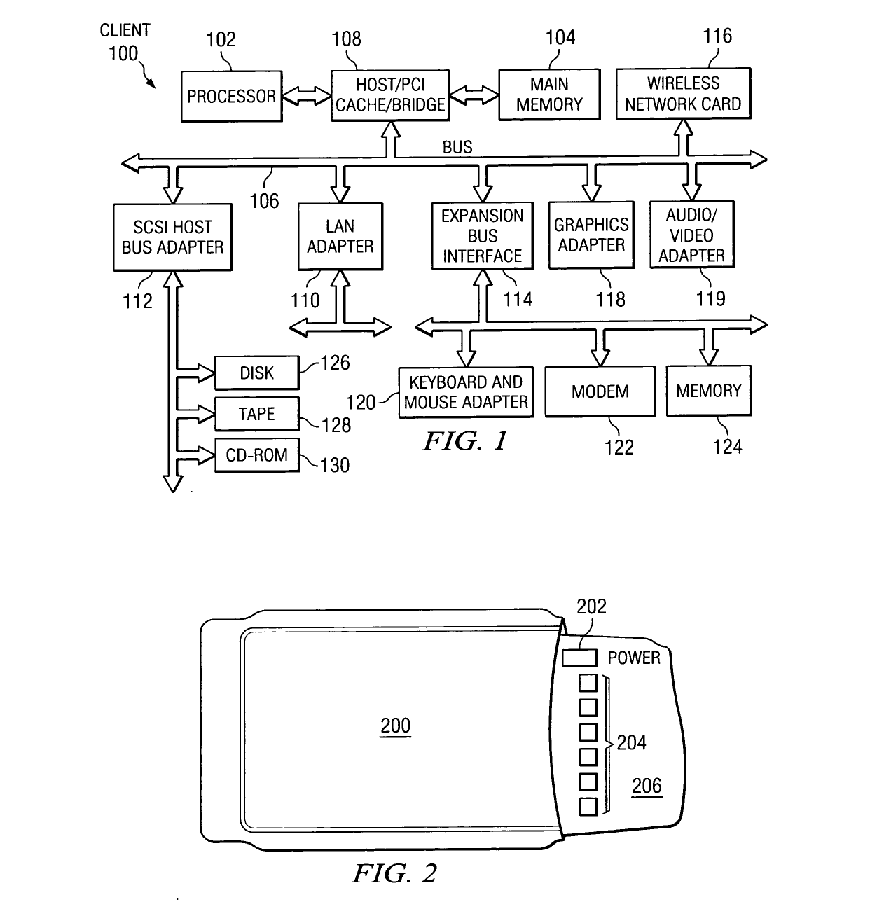

With reference now to the figures and in particular with reference to FIG. 1, a block diagram of a data processing system is shown in which the present invention may be implemented. Data processing system 100 is an example of a computer, in which the present invention may be located. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, small computer system interface SCSI host bus adapter 112, and expansion bus interface 114 are connected to PCI local bus 106 by direct component connection. In contrast, wireless network card 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. SCSI host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system such as Windows XP, which is available from Microsoft Corporation. An object oriented programming system such as Java may run in conjunction with the operating system and provides calls to the operating system from Java programs or applications executing on data processing system 100. “Java” is a trademark of Sun Microsystems, Inc. Instructions for the operating system, the object-oriented programming system, and applications or programs are located on storage devices, such as hard disk drive 126, and may be loaded into main memory 104 for execution by processor 102.

Those of ordinary skill in the art will appreciate that the hardware in FIG. 1 may vary depending on the implementation. Other internal hardware or peripheral devices, such as flash read-only memory (ROM), equivalent nonvolatile memory, or optical disk drives and the like, may be used in addition to or in place of the hardware depicted in FIG. 1. Also, the processes of the present invention may be applied to a multiprocessor data processing system.

For example, data processing system 100, if optionally configured as a network computer, may not include SCSI host bus adapter 112, hard disk drive 126, tape drive 128, and CD-ROM 130. In that case, the computer, to be properly called a client computer, includes some type of network communication interface, such as LAN adapter 110, modem 122, or the like. As a further example, data processing system 100 may be a personal digital assistant (PDA), which is configured with ROM and/or flash ROM to provide non-volatile memory for storing operating system files and/or user-generated data.

The depicted example in FIG. 1 and above-described examples are not meant to imply architectural limitations. For example, data processing system 100 also may be a notebook computer or hand held computer in addition to taking the form of a PDA. Data processing system 100 also may be a kiosk or a Web appliance.

The present invention provides an improved method and apparatus for identifying signal strengths for a wireless adapter. The present invention allows a user to determine or calculate a signal strength without having to open the laptop or even start a data processing system. The mechanism of the present invention includes a signal indicator, such as a liquid crystal display (LCD) or light emitting diode (LED) device that is included with the wireless adapter. Computer instructions or other logic is embedded in the card to determine the signal strength and display this signal strength through the display device.

Further, an audible indication may be provided using the mechanism of the present invention. In the illustrative example, the wireless adapter sends out signals every few seconds and the access point returns packets to the adapter. Depending on the signal strength, the indicator may offer a visual clue to the user. Additionally, a sound generation device may be included in the wireless adapter to set off an alarm if the signal strength drops below a selected level to allow the user to have an audio indication.

Also, signals may be generated audibly to identify the signal strength depending on the particular implementation. Further, this mechanism may be applied to computers that have integrated wireless components rather than discrete adapters. In this type of implementation, the display device may be placed on the exterior of the data processing system to allow the user to easily identify the signal strength.

Turning now to FIG. 2, a pictorial diagram of a wireless adapter card is depicted in accordance with a preferred embodiment of the present invention. In this illustrative example, wireless adapter card 200 provides indicators 202 and 204 within section 206. This section is the portion of wireless adapter 200 that is exposed when placed into a data processing system, such as a laptop computer. In this illustrative example, indicator 202 is a light emitting diode (LED), providing an indication when power is applied to wireless adapter 200. Indicators 204 are a set of LEDs that are used to indicate the strength of a signal received by wireless adapter 200.

As the strength of the signal increases, more LEDs in indicators 204 are lit up to indicate an increase in signal strength. In this manner, a user may identify the signal strength received by wireless adapter 200 without having to open up and start the notebook and then look at software used to identify signal strengths. Indicators 204 provide an easy and convenient mechanism for identifying signal strength received at a particular location without having to look at the screen of a laptop computer or having to manipulate software in the computer to identify signal strengths.

Additionally, wireless adapter 200 may be equipped with a rechargeable battery such that signal strengths may be identified even when the laptop computer is powered off and no power is being supplied to wireless adapter 200.

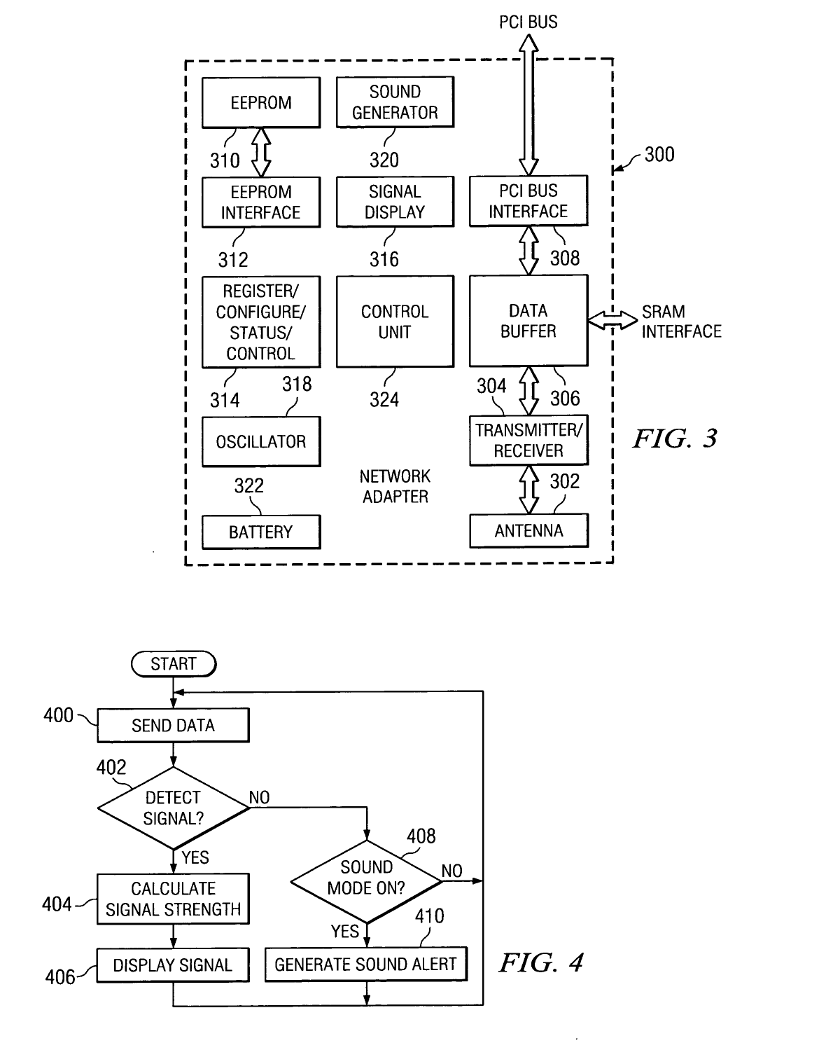

With reference now to FIG. 3, a diagram of a network adapter is depicted in accordance with the preferred embodiment of the present invention. Network adapter 300 is an example of wireless network card 116 in FIG. 1. Wireless network card 300 is a pictorial representation of a network card, such as wireless network card 116 in FIG. 1. These cards may take the form of a PC card used for notebook computers, such as a type II PC card. Wireless network card 300 may be implemented as wireless network card 116 in FIG. 1.

As shown, wireless network card 300 includes antenna 302, transmitter/receiver 304, data buffer 306, and PCI bus interface 308. These components provide a path between the network and the bus of the data processing system. Antenna 302 and transmitter/receiver 304 provide an interface to the network connected to the data processing system. In these examples, this interface is an error interface used to provide a wireless communications link with the network through an access point. PCI bus interface 308 provides an interface to a bus, such as PCI bus 106 in FIG. 1. Data buffer 306 is used to temporarily store data being transmitted and received through wireless network adapter 300. This data buffer also includes a connection to a static random access memory (SRAM) interface to provide for additional storage.

Wireless network card 300 also includes erasable programmable read-only memory (EEPROM) 310 and EEPROM interface 312. EEPROM 310 is a chip, which may contain instructions and other configuration information for wireless network card 300. These instructions may include, for example, instructions for the processes of the present invention. These processes include identifying a signal strength and providing the appropriate indication to the user. Further, different parameters and settings may be stored on EEPROM 310 through EEPROM interface 312.

Register/configuration/status/control unit 314 provides a location to store information used to configure and run processes on wireless network card 300. For example, information used in identifying signal strengths by antenna 302 and displaying those signal strengths on a display or indicator, such as signal display 316 may be stored in register/configure/status/control unit 314. Oscillator 318 provides a clock signal for executing processes on wireless network card 300.

In the illustrative examples, signal display 316 may take the form of a set of LED indicators or an LCD display to provide an indication of signal strength. When taking the form of LED, additional LEDs may be powered as the signal strength increases. With an LCD display, a number or bar may be displayed to indicate signal strength. Further, an audio indicator also may be provided through sound generator unit 320. Sound generator unit 320 may be an integrated speaker in which sounds may be generated to indicate signal strength to a user. Additionally, battery 322 may be integrated into wireless network card 300 to provide power to identify signal strengths, even when the data processing system in which wireless network card 300 is located, is in a powered off state or unconnected to a power source.

Control unit 324 controls different processes and functions performed by wireless network card 300. Control unit 324 may take various forms depending on the particular implementation. For example, control unit 324 may be a processor or an application specific integrated chip (ASIC). In these examples, the processes of the present invention are used to measure the signal strength for a wireless communications link between wireless network card 300 and an access point to a network. If implemented as a processor, the instructions for these processes may be stored in EEPROM 310. If implemented as an ASIC, the different processes may be integrated using circuits within control unit 324.

According to an illustrative embodiment of the present invention, control unit 324 may cause the generation of packets in data buffer 306 for transmission by transmitter/receiver 304 to an access point through antenna 302. In response, data packets may be returned by the access control point. Based on this data exchange, a signal strength may be identified by control unit 324. An indication is generated through signal display 316 or sound generator unit 320 based on the signal strength identified by control unit 324. In this manner a visual key and/or an audio key may be provided to the user with respect to the detected signal strength. Further, sound generator unit 320 may be used to generate an alarm if the signal strength goes below a selected level.

Further, depending on the particular implementation, the components illustrated in wireless network card 300 may be implemented as components within a data processing system having an integrated wireless system network. With such an implementation, signal display 316 is placed on a location outside of the data processing system that provides for easy viewing by a user.

Turning now to FIG. 4, a flowchart of a process for providing an indication of signal strength is depicted in accordance with the preferred embodiment to the present invention. The process illustrative in FIG. 4 may be implemented in a wireless network card, such as wireless network card 300 in FIG. 3. In particular, this process may take the form of instructions executed by control unit 324 in FIG. 3.

The process begins by sending data (step 400). The data in these examples take the form data packets that are directed towards a wireless access control point for the network. A determination is made as to whether a signal is detected (step 402). This determination may be made by identifying whether data packets are received in response to sending data to the wireless access point. If a signal is detected, the signal strength is then calculated (step 404). The IEEE 802.11 standard places specifications on the parameters of the Medium access control (MAC) as well as the physical (PHY) layers of the network. The physical layer, which actually handles the transmission of data between nodes can use either direct sequence spread spectrum, frequency-hopping spread spectrum, or infrared (IR) pulse position modulation. Thereafter, the signal strength is displayed (step 406) with the process then returning to step 400 as described above.

With reference again to step 402, if the signal is not detected, a determination is made as to whether a sound mode is turned on for the card (step 408). If a sound mode is turned on, a sound alert is generated (step 410) with the process then returning to step 400. Otherwise, the process returns to step 400 directly. Further, the sound generation may be made if the signal strength falls below a selected level, other than whether a signal is detected. These levels may be selected by the user or pre-set in the card.

Thus, the present invention provides an improved method and apparatus for indicating signal strength for a data processing system. The mechanism of the present invention provides an indicator that is visible to a user. This indicator generates an indication of signal strength based on the strength of the signal received by the wireless network card.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A wireless network apparatus comprising:
a housing;
a bus interface located inside the housing, wherein the bus interface provides a connection to a data processing system;
a transceiver located inside the housing, wherein the transceiver sends and receives data from a wireless connection;
a data buffer located inside the housing and being connected to the bus interface and the transceiver, wherein the data buffer holds data for transfer between the bus interface and the transceiver;
a display device located on an exterior of the housing, wherein the display device is located on the exterior of the wireless network apparatus in a location for viewing by a human user; and
a control unit located within the housing, wherein the control unit controls the transfer of data through the data buffer, identifies a signal strength for the wireless connection, and displays the signal strength on the display device.

2. The wireless network apparatus of claim 1, wherein the display device is a set of light emitting diodes arranged in an array.

3. The wireless network apparatus of claim 1, wherein the display device is a liquid crystal display.

4. The wireless network apparatus of claim 1, wherein the signal strength is displayed as a bar on the display device.

5. The wireless network apparatus of claim 1 further comprising:
a sound generator unit, wherein the control unit selectively generates a sound using the sound generator unit based on the signal strength.

6. The wireless network apparatus of claim 1, wherein the control unit generates the sound if the signal strength falls below a threshold.

7. The wireless network apparatus of claim 1, wherein the wireless network apparatus is a wireless network card.

8. The wireless network apparatus of claim 1 further comprising:
a battery located within the housing, wherein the battery is used to power the wireless network apparatus when power is unavailable from a data processing system.

9. A method in a wireless network card for indicating a signal strength, the method comprising:
sending data to a network from the wireless network card;
in response to receiving a response to the data, determining the signal strength; and
displaying the signal strength on a display device located on an exterior of the wireless network card.

10. The method of claim 9, wherein the display device is an array of light emitting diodes.

11. The method of claim 9, wherein the display device is a liquid crystal display.

12. The method of claim 9 further comprising:
generating a sound indication in response to the signal strength falling below a threshold level.

13. A data processing system in a wireless network card for indicating a signal strength, the data processing system comprising:
sending means for sending data to a network from the wireless network card;
determining means for determining the signal strength, in response to receiving a response to the data; and
displaying means for displaying the signal strength on a display device located on an exterior of the wireless network card.

14. The data processing system of claim 13, wherein the display device is an array of light emitting diodes.

15. The data processing system of claim 13, wherein the display device is a liquid crystal display.

16. The data processing system of claim 13 further comprising:
generating means for generating a sound indication in response to the signal strength falling below a threshold level.

17. A computer program product in a computer readable medium for indicating a signal strength, the computer program product comprising:
first instructions for sending data to a network from the wireless network card;
second instructions, in response to receiving a response to the data, for determining the signal strength; and
third instructions for displaying the signal strength on a display device located on an exterior of the wireless network card.

18. The computer program product of claim 17, wherein the display device is an array of light emitting diodes.

19. The computer program product of claim 17, wherein the display device is a liquid crystal display.

20. The computer program product of claim 17 further comprising:
fourth instructions for generating a sound indication in response to the signal strength falling below a threshold level.
